(19) United States
(12) Patent Application Publication
(10) Pub. No.: US 2012/0216233 A1
(43) Pub. Date: Aug. 23, 2012

(54) VIRTUAL NETWORK CONSTRUCTING APPARATUS AND METHOD

(75) Inventors: Chang-Woo YOON, Daejeon-si (KR); Eui-Nam HUH, Seoul (KR); Tai-Won UM, Seoul (KR); Jung-Hoon LEE, Gyeonggi-do (KR); Biao SONG, Gyeonggi-do (KR); Hyun-Woo LEE, Daejeon-si (KR); Won RYU, Daejeon-si (KR)

(73) Assignees: University-Industry Cooperation Group of Kyung Hee University, Gyeonggi-do (KR); Electronics and Telecommunications Research Institute, Daejeon-si (KR)

(21) Appl. No.: 13/401,123

(22) Filed: Feb. 21, 2012

(30) Foreign Application Priority Data
Feb. 22, 2011 (KR) 10-2011-0015656

(51) Int. Cl. H04N 21/60; H04N 21/20; H04L 12/28

(52) U.S. Cl. 725/109; 370/255; 725/116

(57) ABSTRACT

A virtual network constructing apparatus and a virtual network constructing method are provided. The virtual network constructing method includes constructing a virtual network on the basis of a Multi-Depot Ring-Star with 2-Depots per Ring (MDRS-2DR) topology, applying the virtual network to an actual network environment, and reflecting a result of the application to reconstruct the virtual network.

### CROSS-REFERENCE TO RELATED APPLICATION

This application claims the benefit under 35 U.S.C. §119(a) of a Korean Patent Application No. 10-2011-0015656, filed on Feb. 22, 2011, the entire disclosure of which is incorporated herein by reference for all purposes.

### BACKGROUND

1. Field

The following description relates to broadcasting system and service technology, and more particularly, to virtual network constructing technology for broadcasting services.

2. Description of the Related Art

Internet protocol television (IPTV) services are multimedia services such as TV, video, audio, text, graphics, and data services provided over IP-based networks whose quality, security, and reliability are ensured. IPTV services include live TV service based on transmission of a multicasting mode, and stored video service such as video on demand (VOD) based on transmission of a unicasting mode.

IPTV services are characterized by various demands of users, and in that the source of content is provided by IPTV service providers as well as various third parties or individual manufacturers. Thus, there is a need for service systems and network constructing methods that are suitable for the IPTV service characteristics.

IPTV service providers construct network topology in view of regional characteristics in order to properly and efficiently provide IPTV services to the users. The constructed topology includes virtual nodes and links, and excludes actual physical network connection.

When an IPTV service provider transmits the constructed topology to a network provider, the network provider embodies the constructed virtual topology over an actual network. In this case, connection and requirements of the virtually constructed topology may not be embodied over the actual network. Then, the IPTV service provider has no alternative but to re-construct the topology from scratch. In this case, the network construction is complicated, and the network provider is reluctant to open information about his/her own network resources. For this reason, the aforementioned problem may recur.

### SUMMARY

The following description relates to a virtual network constructing apparatus and method in which a virtual network topology model suitable for Internet protocol television (IPTV) services and an algorithm for resolving a reconstruction problem that a virtual network must be constructed from scratch due to a difference between the virtual network and a physical network are proposed.

According to an exemplary aspect, there is provided a virtual network constructing method, which includes: constructing a virtual network on the basis of a Multi-Depot Ring-Star with 2-Depots per Ring (MDRS-2DR) topology; and applying the virtual network to an actual network environment, and reflecting a result of the application to reconstruct the virtual network.

According to another exemplary aspect, there is provided a virtual network constructing method, which includes: deciding local video servers, which are depots in which content replicas are to be stored, to store the replicas; and selecting the local video servers in which the replicas are stored, the local video servers in which the replicas are not stored, and local cache servers on an actual network through feedback, and connecting the servers via links to construct a virtual network. The virtual network is based on an MDRS-2DR topology.

According to still another exemplary aspect, there is provided a virtual network constructing apparatus, which includes: a virtual network constructing unit that constructs a virtual network on the basis of an MDRS-2DR topology, reflects a result of application of a virtual network applying unit, and reconstructs the virtual network; and the virtual network applying unit that applies the virtual network to an actual network environment.

Other features and aspects will be apparent from the following detailed description, the drawings, and the claims.

### BRIEF DESCRIPTION OF THE DRAWINGS

FIG. 1 is a reference view for explaining a concept of IPTV services using a virtual network according to an embodiment of the present invention.

FIG. 2 shows the construction of a virtual network constructing apparatus according to an embodiment of the present invention.

FIG. 3 is a reference view showing an MDRS-2DR topology according to an embodiment of the present invention.

FIG. 4 is a flowchart showing how a virtual network constructing apparatus decides a depot in which content replicas are stored and stores the replicas according to an embodiment of the present invention.

FIG. 5 is a flowchart showing how a virtual network constructing apparatus selects servers via feedback from an InP and connects a link between the servers according to an embodiment of the present invention.

FIG. 6 is a reference view for explaining the virtual network constructed through the algorithms of FIGS. 4 and 5.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

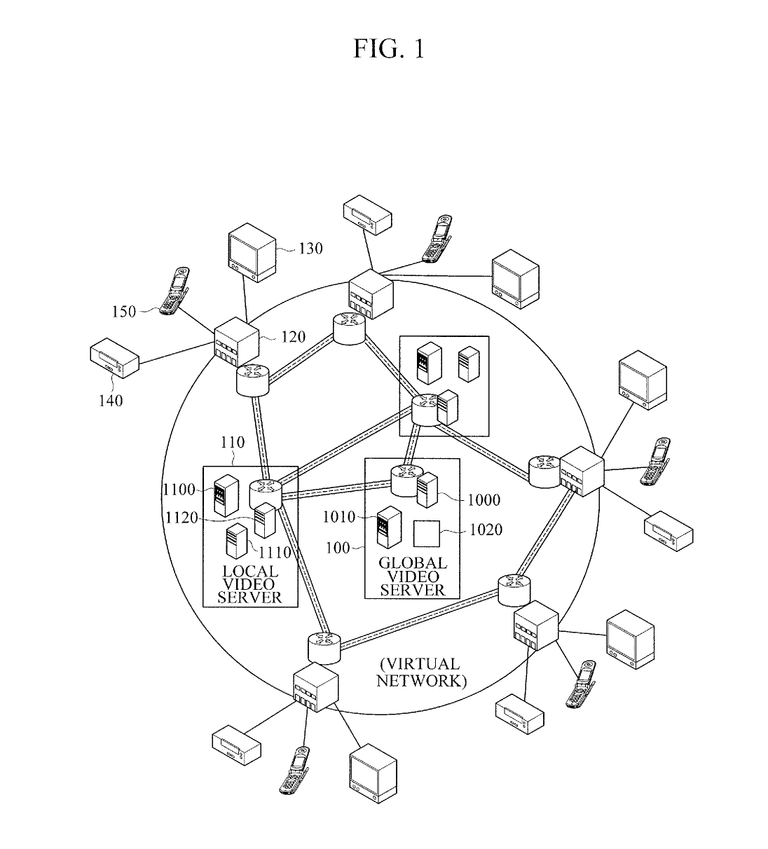

FIG. 1 is a reference view for explaining a concept of Internet protocol television (IPTV) services using a virtual network according to an embodiment of the present invention.

The present invention is used to guarantee stability to content services having a plurality of sources copied from content. Further, the present invention provides services cooperating with network providers using a virtual network.

According to an embodiment, the content services may be IPTV services. The IPTV services require a high-performance network based on meeting various demands of users. The virtual network for providing the IPTV services is as shown in FIG. 1.

Referring to FIG. 1, a model for the IPTV services using the virtual network includes a global video server 100, a plurality of local video servers 110, each of which is connected to the global video server 100 and receives content from the global video server 100, and a plurality of local cache servers 120, each of which is connected to one of the local video servers 110 on an edge of the virtual network and receives content from the connected local video server 110.

The global video server 100 is a producer that directly produces content and provides IPTV services. The content includes moving pictures as well as a variety of programs so as to be suitable for various services of IPTV. The global video server 100 includes a streaming server 1000, a content server 1010, and a program source 1020. The streaming server 1000 is used for real-time broadcasting that produces content and simultaneously provides services. The global video server 100 transmits the produced content to the local video servers 110. The transmitted content is used to provide the IPTV services.

The local video server 110 includes a transcoder 1110 converting the content in a format suitable for broadcasting, a content server 1100 storing the content, and a streaming server 1120 transmitting moving pictures.

The local cache server 120 receives the content from the local video server 110 via a link of the virtual network, and services the received content to user terminals. The user terminal may include, but is not limited to, an ordinary set-top box 130, an IP set-top box 140, or a mobile terminal 150.

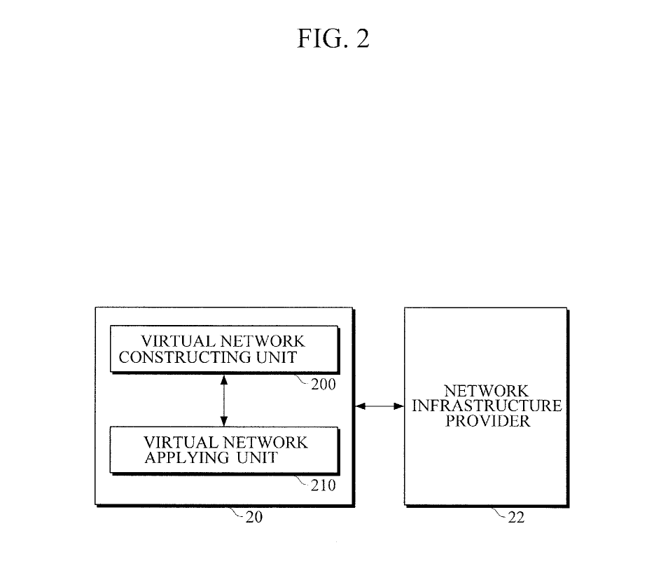

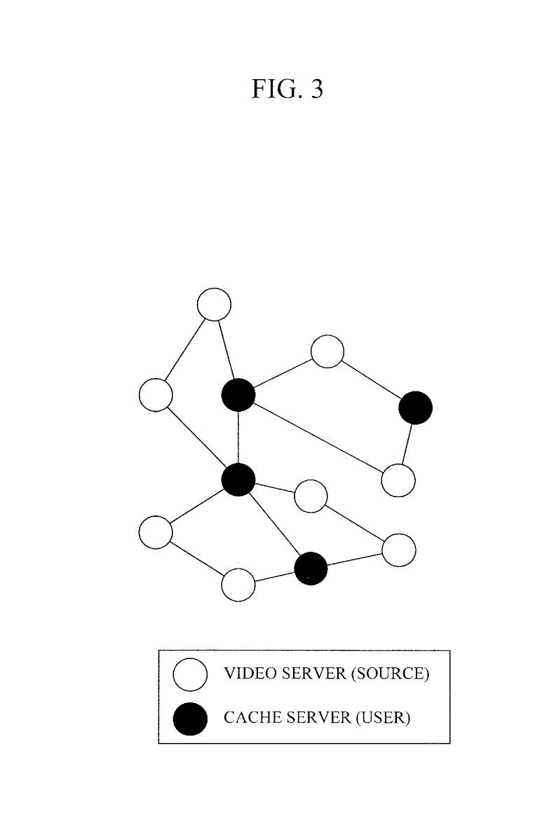

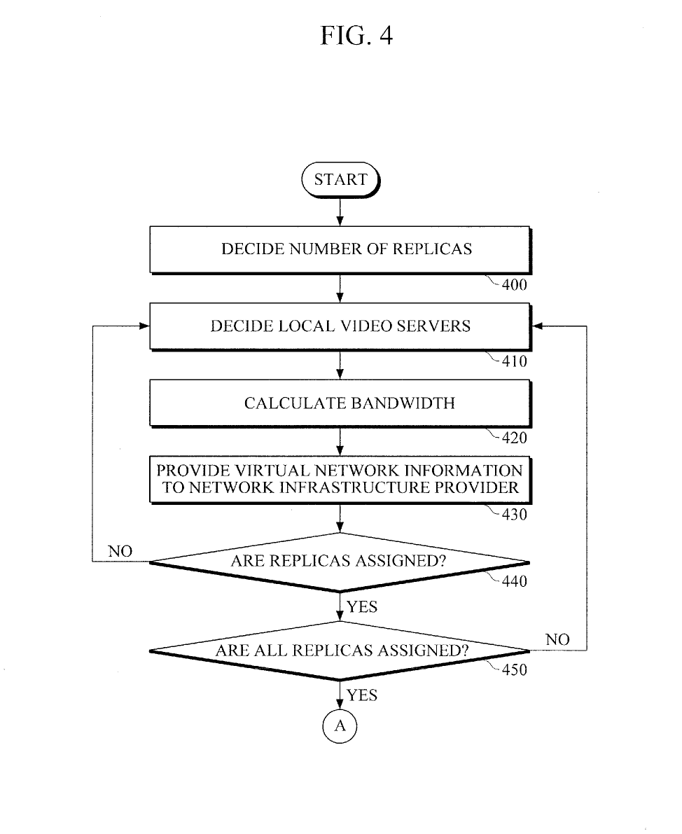

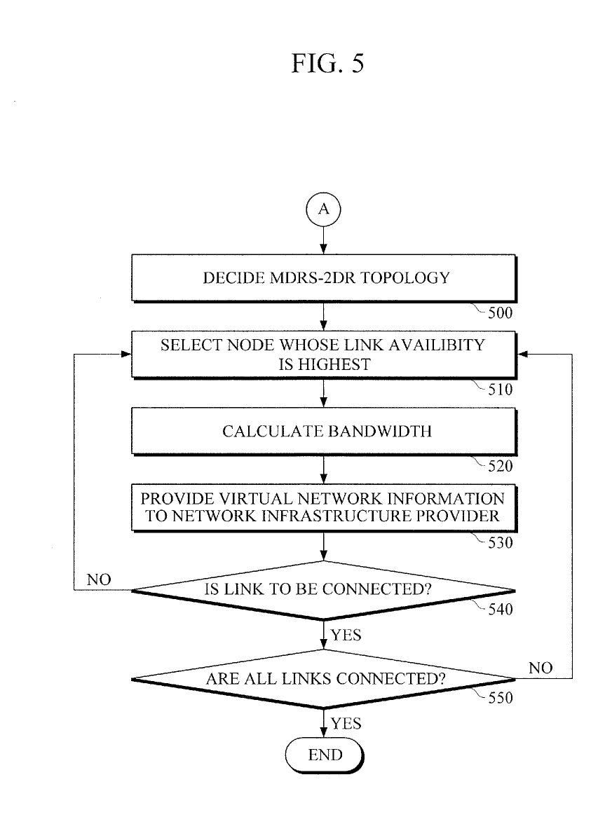

Meanwhile, to provide flexible and stable content services, a construction of the virtual network and a procedure used to embody the virtual network into an actual network are important. The present invention proposes a model and algorithm for resolving these two issues. Hereinafter, the construction of an apparatus for constructing the virtual network according to an embodiment of the present invention will be described with reference to FIG. 2, and the virtual network established using a topology model of the present invention will be described with reference to FIG. 3. Further, an algorithm for embodying the virtual network into the actual network will be described with reference to FIGS. 4 and 5.

FIG. 2 shows the construction of the virtual network constructing apparatus 20 according to an embodiment of the present invention.

Referring to FIGS. 1 and 2, the virtual network constructing apparatus 20 includes a virtual network constructing unit 200 and a virtual network applying unit 210. The virtual network constructing apparatus 20 may include, but is not limited to, an apparatus for constructing a virtual network to provide content services including IPTV services.

The virtual network constructing unit 200 constructs a virtual network on the basis of a Multi-Depot Ring-Star with 2-Depots per Ring (MDRS-2DR) topology. The MDRS-2DR topology has two depots per ring. The virtual network applying unit 210 applies the virtual network constructed by the virtual network constructing unit 200 to an actual network. Here, the virtual network constructing unit 200 reconstructs the virtual network by reflecting a result of the application of the virtual network applying unit 210.

According to an embodiment, the virtual network constructing unit 200 decides the number of content replicas, and a local video server in which the replicas are stored. The virtual network constructing unit 200 determines whether the replicas are to be stored in the decided local video server in an actual network environment, and stores the replicas in the local video server according to a result of the determination. An algorithm according to this construction will be described with reference to FIG. 4.

According to an embodiment, the virtual network constructing unit 200 creates a cluster including other local video servers in which no replicas are stored, determines whether two depots near the centroid of the cluster are to be connected with the other local video servers in which no replicas are stored and which are included in the cluster in an actual network environment via links, and link-connects the depots with the other local video servers according to a result of the determination. An algorithm according to this construction will be described with reference to FIG. 5.

According to an embodiment, the virtual network constructing unit 200 sequentially selects local video servers according to a level of link availability including a sub-network scale and the number of users within the cluster, and determines whether two depots near the centroid of the cluster are to be connected with the selected local video servers via links.

FIG. 3 is a reference view showing an MDRS-2DR topology according to an embodiment of the present invention.

Referring to FIG. 3, the present invention constructs a virtual network using an MDRS-2DR topology. A model for the MDRS-2DR topology has two depots per ring. The MDRS-2DR topology model is a stable model that is capable of continuously maintaining media service despite interruption related to the link connection or the depot. That is, when any interruption occurs on a certain link, it is possible to provide service in a different direction according to a characteristic of the ring-shaped topology. Further, when a problem occurs at a certain depot, it is possible to provide service via a different depot according to a characteristic of the topology having the two depots.

FIGS. 4 and 5 show an algorithm for resolving a problem that a virtual network must be reconstructed from scratch when it is difficult to embody the virtual network into an actual network via a network infrastructure provider (hereinafter referred to as “InP”). The InP is an actual network InP. The inventive virtual network constructing apparatus reconstructs the virtual network based on feedback of whether nodes and links of the virtual network are to be connected within the actual network from the InP.

FIG. 4 is a flowchart showing how a virtual network constructing apparatus decides a depot in which content replicas are stored and stores the replicas according to an embodiment of the present invention.

Referring to FIG. 4, a virtual network constructing apparatus, for instance an IPTV service provider, decides the number of content replicas (S400). Here, the number of content replicas may be decided in view of a regional location of a service area. Local video servers in which the replicas are stored are selected (S410). Since it is inefficient to store the replicas in all of the local video servers, some video servers in which the replicas are stored are selected.

Then, the IPTV service provider calculates a bandwidth according to an amount of content and the number of users (S420), and provides information about links according to the bandwidth to an InP (S430). As a result, the IPTV service provider determines whether replicas are to be assigned to the selected local video servers (S440). If impossible, the IPTV service provider selects new local video servers (S410). In contrast, if possible, the IPTV service provider assigns the replicas to the selected local video servers, and repeats the previous steps S410, S420, S430, and S440 until all the replicas are assigned (S450).

FIG. 5 is a flowchart showing how a virtual network constructing apparatus selects servers via feedback from an InP and connects a link between the servers according to an embodiment of the present invention.

Referring to FIG. 5, when replicas are assigned to local video servers, a virtual network constructing apparatus, for instance an IPTV service provider, decides an MDRS-2DR topology to suitable for IPTV services (S500). The IPTV service provider creates a cluster on the basis of local video servers in which no replicas are stored. To create the cluster, a location-based k-means algorithm may be used. A k-means algorithm refers to an algorithm that partitions predetermined objects into k clusters, and operates so as to minimize the divergence in distance difference from each cluster. The number of local video servers within the cluster is correlated with the number of clusters. The number of clusters may be selected by the IPTV service provider according to network and service environments. When a cluster is created, the IPTV service provider searches for two depots nearest the centroid of the cluster. The depot manages one or more rings.

Then, the IPTV service provider selects a busiest node, which is to be connected with the depot for the first time, among the local video servers with no replicas (S510). The reason the busiest node is selected with priority is that there are many users to which the node has to provide services and many local cache servers to be connected to sub-links. Accordingly, the corresponding node is guaranteed availability to construct topology to be connected to sub-links with priority. The preferential selection of the node with the highest link availability is efficient in reducing a burden of network reconstruction.

Subsequently, the IPTV service provider calculates a bandwidth (S520), provides the InP with information about links according to the calculated bandwidth (S530), and determines whether the selected local video servers are connected with two depots via links (S540). As a result of the determination, when the InP succeeds in assigning a corresponding node, the IPTV service provider repeats the previous steps S510, S520 and S530 to select a next busiest node to be connected via a link, calculate a bandwidth, and provide an InP with information about links until the InP assigns all nodes. If the InP fails to assign the node, the IPTV service provider repeats the previous steps S500, S510, S520 and S530 to select a node to be connected via another link, calculate a bandwidth, and provide an InP with information about links.

Furthermore, when all the local video servers and all the links are assigned within the actual network, the IPTV service provider constructs small-scale ring topology where each local video server is to be connected with the local cache servers. The local video server is connected with the local cache servers via the links in the same method of linking the local video servers with the replicas and the local video servers without the replicas as described above.

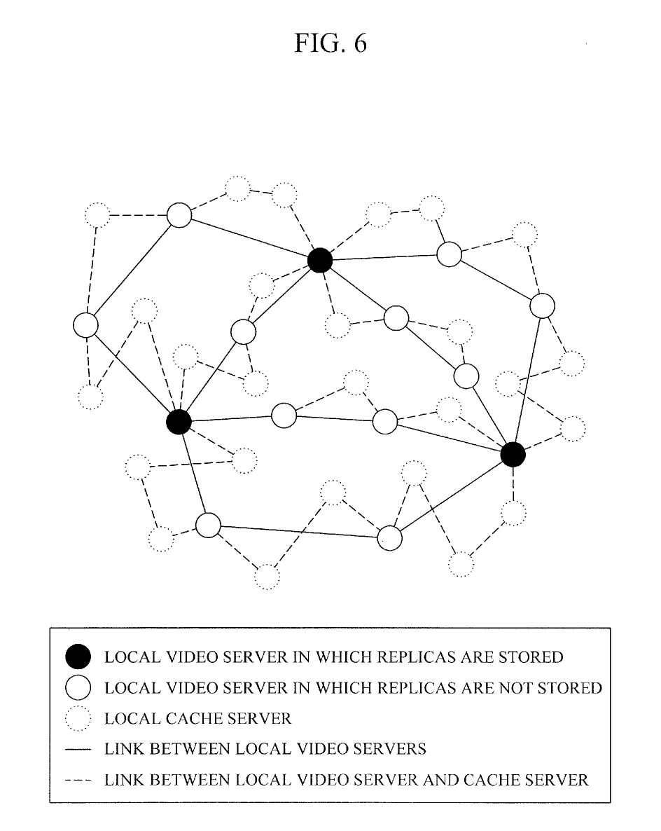

FIG. 6 is a reference view for explaining the virtual network constructed through the algorithms of FIGS. 4 and 5.

FIG. 6 shows a result of performing the algorithm of FIG. 4 used to decide the depot in which the content replicas are stored and store the replicas, and the algorithm of FIG. 5 used for the link connection between the servers, and establishing a virtual network.

The MDRS-2DR topology model proposed in the present invention may be used to guarantee stability to the IPTV services as well as all the services having various sources copied from the content. Further, the algorithm that embodies the virtual network model of reducing the burden of network reconstruction into the actual network will be the prototype of a model of establishing services cooperating with network providers using the virtual network in the future.

As apparent from the above description, it is possible to resolve the problem that the virtual network must be reconstructed from scratch on the basis of reliable information when the virtual network cannot be properly embodied into the actual network. That is, it is possible to provide the virtual network topology to the network infrastructure provider, to receive feedback of whether the nodes are to be selected and whether the links are to be formed, and to sequentially reconstruct the virtual network. Thereby, it is possible to construct a stable network suitable for the IPTV services.

Furthermore, the virtual network is constructed on the basis of the MDRS-2DR topology. Thus, even when failure occurs at one depot within the MDRS-2DR topology, it is possible to provide continuous content services using the other depot. Further, even when failure occurs on a certain link connected with the depot, it is possible to provide continuous content services using another link. The MDRS-2DR topology model can be used to guarantee stability to the IPTV services as well as all the services having various sources copied from content.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtual network constructing method of a virtual network constructing apparatus, comprising:
constructing a virtual network on the basis of a Multi-Depot Ring-Star with 2-Depots per Ring (MDRS-2DR) topology; and
applying the virtual network to an actual network environment, and reflecting a result of the application to reconstruct the virtual network.

2. The virtual network constructing method according to claim 1, wherein the virtual network constructing apparatus is an apparatus for constructing the virtual network to provide content services including Internet protocol television (IPTV) services.

3. The virtual network constructing method according to claim 1, wherein the MDRS-2DR topology is a topology that, when an interruption occurs at one of the two depots, provides continuous content services using the other depot, and when an interruption occurs on a certain link connected to the depot, provides continuous content services using another link connected to the depot.

4. The virtual network constructing method according to claim 1, wherein the reconstructing of the virtual network includes providing the MDRS-2DR topology to a network infrastructure provider establishing an actual network infrastructure, and receiving feedback of whether nodes are to be selected and whether links are to be formed.

5. A virtual network constructing method comprising:
deciding local video servers, which are depots in which content replicas are to be stored, to store the replicas; and
selecting the local video servers in which the replicas are stored, the local video servers in which the replicas are not stored, and local cache servers on an actual network through feedback, and connecting the servers via links to construct a virtual network, the virtual network being based on a Multi-Depot Ring-Star with 2-Depots per Ring (MDRS-2DR) topology.

6. The virtual network constructing method according to claim 5, wherein the deciding of the local video servers to store the replicas includes:
deciding the number of replicas and the local video servers in which the replicas are to be stored and calculating a bandwidth according to an amount of content and the number of users;
providing information about links according to the calculated bandwidth to a network infrastructure provider, and determining whether the replicas are to be stored in the decided local video server; and
storing the replicas in the local video servers according to a result of the determination.

7. The virtual network constructing method according to claim 5, wherein the constructing of the virtual network being based on the MDRS-2DR topology includes:
creating a cluster including the local video servers in which the replicas are not stored and selecting two depots near the centroid of the created cluster;
selecting the local video servers according to a preset criterion among the local video servers in which the replicas are not stored within the cluster, and calculating a bandwidth;
providing information about links according to the calculated bandwidth to a network infrastructure provider, and determining whether the selected local video servers are to be connected with the selected two depots via the links; and
connecting the links of the selected two depots and the selected local video servers according to a result of the determination.

8. The virtual network constructing method according to claim 7, wherein the selecting of the local video servers according to the preset criterion among the local video servers, in which the replicas are not stored within the cluster, to calculate the bandwidth includes sequentially selecting the local video servers according to a level of link availability including a sub-network scale and the number of users.

9. The virtual network constructing method according to claim 7, wherein the constructing of the virtual network being based on the MDRS-2DR topology further includes connecting the link-connected local video servers with subordinate local cache servers via the links.

10. A virtual network constructing apparatus comprising:
a virtual network constructing unit that constructs a virtual network on the basis of a Multi-Depot Ring-Star with 2-Depots per Ring (MDRS-2DR) topology, reflects a result of application of a virtual network applying unit, and reconstructs the virtual network; and
the virtual network applying unit that applies the virtual network to an actual network environment.

11. The virtual network constructing apparatus according to claim 10, wherein:
the virtual network applying unit provides the MDRS-2DR topology to a network infrastructure provider; and
the virtual network constructing unit receives feedback of whether nodes are to be selected and whether links are to be connected from the network infrastructure provider, and reconstructs the virtual network.

12. The virtual network constructing apparatus according to claim 10, wherein the virtual network constructing unit decides the number of content replicas and local video servers in which the replicas are to be stored, determines whether the replicas are to be stored in the decided local video servers in an actual network environment, and stores the replicas in the local video servers according to a result of the determination.

13. The virtual network constructing apparatus according to claim 10, wherein the virtual network constructing unit creates a cluster including the local video servers in which the replicas are not stored, determines whether the local video servers in which the replicas are not stored within the cluster are to be connected with two depots near the centroid of the created cluster in the actual network environment, and connects the local video servers with the two depots via links according to a result of the determination.

14. The virtual network constructing apparatus according to claim 13, wherein the virtual network constructing unit sequentially selects the local video servers according to a level of link availability including a sub-network scale and the number of users within the cluster, and determines whether the selected local video servers are to be connected with the two depots near the centroid of the cluster via the links.

15. The virtual network constructing apparatus according to claim 10, wherein the virtual network constructing apparatus is an apparatus for constructing the virtual network to provide content services including Internet protocol television (IPTV) services.
